(19) United States
(12) Patent Application Publication
(10) Pub. No.: US 2005/0233161 A1
(43) Pub. Date: Oct. 20, 2005

(54) Thermosetting adhesive sheet with electroconductive and thermoconductive properties

(76) Inventors: Masaaki Takeda, Kanagawa (JP); Akihiko Mitsui, Tokyo (JP); Kohichiro Kawate, Tokyo (JP); Shigeyoshi Ishii, Tokyo (JP)

Correspondence Address: 3M INNOVATIVE PROPERTIES COMPANY, PO BOX 33427, ST. PAUL, MN, 55133-3427, US

(21) Appl. No.: 10/508,736

(22) PCT Filed: Apr. 1, 2003
(86) PCT No.: PCT/US03/09907

§ 371 Date: May 19, 2005

(30) Foreign Application Priority Data
Apr. 2, 2002 (JP) 2002-100200

(51) Int. Cl. B32B 27/00

(52) U.S. Cl. 428/500

(57) ABSTRACT

A thermosetting adhesive sheet with electroconductive and thermoconductive properties, which comprises a thermosetting adhesive sheet composed of a thermosetting adhesive composition comprising an ethylene-glycidyl(meth)acrylate copolymer and a carboxyl group-containing rosin, where crosslinking is formed between the ethylene of the copolymer by electron beam radiation, and having at least one through-opening region formed at a prescribed location, and further including a low melting point solder placed within said through-opening region(s) formed at the prescribed location(s).

### FIELD OF THE INVENTION

The present invention relates to a thermosetting adhesive sheet with electroconductive and thermoconductive properties. The adhesive sheet is particularly useful for adhesion between electronic elements, such as integrated circuit chips and radiator plates, that can radiate heat.

### BACKGROUND

In mounted-type electronic parts known as TAB or T-BGA (Tape Ball Grid Array), such as the one shown cross-sectionally in FIG. 1, an integrated circuit (IC) chip A is connected to a TAB (tape having metal wiring on an insulating film) B, and solder balls C formed on the TAB B are in connection with a wiring board (not shown). In order to radiate heat generated from the IC and to prevent electrification, the IC chip A is attached to a radiator plate E by an electroconductive adhesive D. For stabilization of the TAB B connected to the IC chip A and to increase the strength of the electronic part as a whole, a stiffener F is disposed between the TAB B and the radiator plate E by way of a thermosetting adhesive G. In the electronic part shown in this drawing, a ground conductive path is formed to eliminate noise which electrifies the IC chip A, and this is formed by soldering from the radiator plate E to the TAB B. Traditionally, the electroconductive adhesive used has traditionally been an electroconductive adhesive mixed with silver powder, such as an electroconductive silver paste.

However, because the aforementioned electroconductive adhesive has a large amount of silver powder or other metal filler dispersed in an insulating polymer or monomer, the material cost can be high. Thus, in the TAB type shown in FIG. 1, it has been difficult to apply large-area adhesion and, consequently, inexpensive solder has been used for grounding from the radiator plate, thus complicating the mounting step. In recent years, with increasing power consumption due to greater integration of IC chips, the amount of heat radiation has also been increasing. Because the aforementioned electroconductive adhesives incorporating silver powder or the like generally have a thermal conductivity of 3-5 W/mK, they fail to be an adequate heat release strategy for IC chips with high heat radiation.

Less expensive electroconductive adhesive sheets with high thermal conductivity have therefore been desired. Japanese Unexamined Patent Publication SHO No. 11-21522 relates to a thermoconductive adhesive sheet having a plurality of striated thermoconductive sections and striated adhesive sections alternately laid onto one or both sides of a support substrate. The striated thermoconductive section is made by coating a thermoconductive paste (a mixture of thermoconductive powder such as silver and a resin solution in a solvent). A circular disk having a plurality of adhesive sheets and thermoconductive sheets integrally laminated is rotated at low temperature and cut around the perimeter in a continuous manner at a specified thickness. The adhesive sheet is used for anchoring of an electronic part onto a temperature sensor.

Japanese Unexamined Patent Publication HEI No. 5-259671 relates to a heat radiating sheet having a plurality of thermoconductive fillers dispersed in a matrix resin. The thermoconductive fillers penetrate in the direction of thickness of the radiating sheet while the thermoconductive fillers are oriented in the matrix resin in such a manner that both edges are exposed on the surface of the matrix resin. The matrix resin used is silicone rubber or a polyolefin-based elastomer in order to obtain adhesion with an object to be cooled. The electroconductive fillers are typically metal materials such as gold, copper, aluminum or the like. The fillers used are exposed on the sheet surface and therefore a high viscosity adhesive cannot easily be used as the matrix resin. The exposed sections of the fillers are treated to prevent formation of a resin film by masking agents such as paraffin or styrene rubber, and therefore coating of resins can be very difficult.

Several patent documents relate to anisotropic electroconductive adhesive films for electrical connection of microelectrodes or microwirings while maintaining electrical insulation between each of the electrodes or wirings. Japanese Unexamined Patent Publication HEI No. 8-306415 and Japanese Unexamined Patent Publication HEI No. 3-266306 relate to anisotropic electroconductive adhesive films. Therein, a plurality of fine through-holes is formed in an insulating film of polyimide or the like running in the direction of its thickness, and a metal substance is packed into the plurality of through-holes. The metal substance is packed by forming riveted metal protrusion bumps thereby preventing flaking of the metal from the film. Plating, sputtering and similar methods are used to form the riveted bumps. These anisotropic electroconductive adhesive films also provide electrical connection for microwiring and the like, and the through-holes, can be as small as 15-100 μm. The thermal conductivity of such adhesive films can be low, and they may not be well suited for heat radiation purposes.

Japanese Unexamined Patent Publication BEI No. 5-205531 relates to an anisotropic electroconductive film having a metal film packed into holes formed in an insulating adhesive sheet. The metal film is packed by transferring a metal film formed in a transferable fashion on a transfer sheet into the holes formed in the adhesive sheet. The packing requires a metal film with a greater area than the packing area. The packing is accomplished by a press-cutting system, and the metal film may flake during the process or during transport. Moreover, such anisotropic electroconductive adhesive films, like the anisotropic electroconductive adhesive films described in Japanese Unexamined Patent Publication HEI No. 8-306415 and Japanese Unexamined Patent Publication HEI No. 3-266306, serve as electrical connection for microwirings and the like and therefore have low thermal conductivity and are poorly suited for heat radiation purposes.

### SUMMARY

The present invention provides a thermosetting adhesive sheet that has high thermoconductive and electroconductive properties, and has lower cost than other alternatives.

Specifically, the invention provides a thermosetting adhesive sheet with electroconductive and thermoconductive properties, which comprises a thermosetting adhesive sheet composed of a thermosetting adhesive composition comprising an ethylene-glycidyl(meth)acrylate copolymer and a rosin containing a carboxyl group, where crosslinking is formed between the ethylene portion of the copolymer by electron beam radiation. The adhesive sheet has at least one through-opening region formed at a prescribed location, and further has a low melting point solder placed within the through-opening region formed at the prescribed location.

This thermosetting adhesive sheet can impart high electric conductivity and high thermal conductivity in the direction of thickness, and only in the prescribed region. It is also possible to reduce the amount of metal used in comparison with conventional electroconductive adhesives. This type of thermosetting adhesive sheet is particularly useful for adhesion of electronic elements such as semiconductor elements onto radiator plates.

### BRIEF DESCRIPTION OF THE DRAWINGS

FIG. 1 is a cross-sectional view of a conventional electronic part formed by a TAB system.

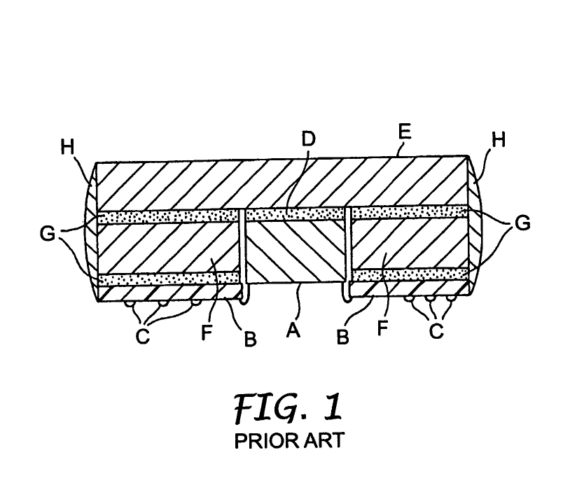

FIG. 2 is an exploded perspective view of an exemplary embodiment of an electronic part using a thermosetting adhesive sheet according to the present invention.

FIG. 3 is a top view of a thermosetting adhesive sheet of the invention such as used in the examples.

FIG. 4 is a schematic diagram of a thermal conductivity measuring apparatus.

### DETAILED DESCRIPTION OF THE INVENTION

Thermosetting Adhesive Sheet

The thermosetting adhesive sheet of the invention uses a thermosetting adhesive sheet composed of a thermosetting adhesive composition comprising an ethylene-glycidyl (meth)acrylate copolymer and a rosin containing a carboxyl group. Crosslinking is formed between the ethylene units of the copolymer by electron beam radiation. The adhesive sheet has at least one through-opening or via at a prescribed location or locations. The adhesive sheet further includes low melting point solder placed within the prescribed location in order to confer electric conductivity and thermal conductivity. In this detailed description and in the examples, all numbers are assumed to be modified by the term “about”.

The thermosetting adhesive composition (hereinafter also referred to simply as “adhesive composition”) is solid at ambient temperatures, but can be thermo-compression bonded at a prescribed temperature with relatively low pressure and in a short time (for example, a temperature of 100-200° C., a pressure of 0.1-10 kg/cm² and a time of 0.1-30 seconds). Heating during or after compression bonding, also called postcuring, can effect curing (crosslinking) without the need for moisture. Throughout the present specification, the term “ambient temperature” will refer to approximately 25° C.

The thermosetting temperature normally exceeds 150° C., and the heating time is usually one minute or longer. The thermosetting reaction is essentially a reaction between the epoxy groups of the ethylene-glycidyl(meth)acrylate copolymer and the carboxyl groups of the carboxyl group-containing rosin, and therefore little to no reaction by-products, such as water, are produced.

The precursor of the adhesive composition melts at a lower temperature than common hot-melt adhesives (for example, below 120° C.), thus allowing easy hot-melt coating. Also, the fluidity during the hot melt process is relatively high, so little to no solvent is required for coating or film formation. The term “precursor” refers to the adhesive in the state prior to formation of intermolecular crosslinking by electron beam radiation.

The intermolecular crosslinking is formed between the ethylene units of the ethylene-glycidyl(meth)acrylate copolymer. The crosslinking reaction is promoted between the ethylene units when they undergo radical activation by the electron beam radiation.

The crosslinked structure improves the elastic modulus during thermo-compression bonding of the adhesive composition. The elastic modulus improvement keeps the adhesive composition layer, which is sandwiched between two adherends, from undergoing excessive flow during the thermo-compression bonding operation. The elastic modulus improvement also effectively prevents reduction in adhesive performance that may result when the adhesive layer thickness may not be adequate.

The elastic modulus of the adhesive composition can be specified by the storage elastic modulus (G′) at 150° C. But because the curing reaction of the adhesive composition is promoted by heating, it may not exhibit a fixed elastic modulus at this temperature. The storage elastic modulus of the adhesive composition is therefore defined according to the following conditions. A sample is taken from the adhesive composition before use (before it is applied onto the adherend, i.e. before thermo-compression bonding, etc.), and a dynamic viscoelastometer is used for measurement of the storage elastic modulus at a shear rate of 6.28 rad/sec while elevating the temperature of the sample from 80° C. to 280° C. at a rate of 5° C./min. The value of the storage elastic modulus at 150° C. on the obtained chart (temperature vs. storage elastic modulus) is defined as the “storage elastic modulus” of the adhesive composition.

The storage elastic modulus of the adhesive composition as defined above is usually in the range of from 1×10⁴ to 1×10⁶ dyne/cm², and particularly suited from 2×10⁴ to 3×10⁵ dyne/cm². If the storage elastic modulus is too small, the effect of preventing flow during the thermo-compression bonding operation is reduced, while if it is too large, the temporary adhesion during thermo-compression bonding operations, e.g., for 30 seconds or less, may be poor. If so, the part may peel from the adhesive sheet during transport of the adhered part to further processing steps.

The curing reaction between the glycidyl(meth)acrylate copolymer and the carboxyl group-containing rosin occurs gradually at heating temperatures for melt coating or press molding. Thus there is little to no gelling of the adhesive composition precursor nor any significant increase in the viscosity to a level which could cause problems for continuous production. Also, because the curing reaction typically does not occur below 90° C., it is possible to increase the storage stability of the adhesive composition. On the other hand, because of rapid acceleration of the curing reaction at temperatures above 150° C. it is possible to shorten the thermosetting treatment time for postcuring.

The adhesive composition used for the invention may be produced by molding the adhesive composition precursor into a sheet and irradiating the molded sheet with an electron beam to form a crosslinked structure between the copolymer molecules.

When the adhesive composition is heated at the prescribed temperature, the ethylene-glycidyl(meth)acrylate copolymer undergoes curing reaction with the carboxyl group-containing rosin, and functions to increase the cohesive force of the cured product. A high cohesive force is advantageous for improving the adhesive performance, such as the peel adhesive strength.

In addition, the ethylene-glycidyl(meth)acrylate copolymer has the function of facilitating melt coating when the adhesive composition precursor is melted at relatively low temperatures. It also imparts satisfactory thermal adhesion to the adhesive composition. “Thermal adhesion” means adhesion to an adherend at the cooling and solidification stages after the adhesive composition has been melted and attached to the adherend.

The ethylene-glycidyl(meth)acrylate copolymer can be formed by polymerization of, for example, a monomer mixture comprising glycidyl(meth)acrylate monomers and ethylene monomers as the starting monomers. So long as the effect of the invention is not hindered, a third monomer such as propylene, alkyl(meth)acrylate or vinyl acetate may also be used in addition to the aforementioned monomers. In such cases, the minimum carbon number of the alkyl group of the alkyl(meth)acrylate will be 1 while the amximum carbon number will be 8. Suitable examples of ethylene-glycidyl(meth)acrylate copolymers include a bipolymer of glycidyl(meth)acrylate and ethylene, a terpolymer of glycidyl(meth)acrylate, vinyl acetate and ethylene, and a terpolymer of glycidyl(meth)acrylate, ethylene and alkyl(meth)acrylate.

The ethylene-glycidyl(meth)acrylate copolymer comprises a repeating unit polymerized from a monomer mixture of glycidyl(meth)acrylate and ethylene, in a proportion of at least 50 wt % and particularly suited at least 75 wt % with respect to the total polymer. The polymerization ratio of the glycidyl(meth)acrylate (G) and ethylene (E) in the repeating unit is preferably 50:50 to 1:99, and particularly suited at 20:80 to 5:95. If the ethylene content is too low, the compatibility with the rosin may be reduced to the point where a uniform composition cannot be achieved, and the electron beam crosslinking may be hampered. Conversely, if the ethylene content is too high, the adhesion performance may be reduced. The ethylene-glycidyl(meth)acrylate copolymer may be used as a single type or as a mixture of two or more types.

The melt flow rate (hereunder abbreviated as “MFR”) of the ethylene-glycidyl (meth)acrylate copolymer, as measured at 190° C., is usually at least 1 g/10 minutes. A rate of at least 1 g/10 minutes will allow thermal adhesion of the adhesive composition. In order to effectively facilitate melt coating of the adhesive composition precursor, a rate of at least 150 g/10 min is particularly suited. If the MFR is too large, the cohesive force of the cured composition may be reduced; the MFR is most particularly suited in the range of 200-1000 g/10 min. Here, “MFR” is the value as measured according to Japanese Industrial Standard (JIS) K6760. The weight-average molecular weight of the ethylene-glycidyl (meth)acrylate copolymer should be selected so that the MFR falls within this range.

The minimum proportion of the ethylene-glycidyl(meth)acrylate copolymer in the adhesive composition is 10 wt % while the minimum proportion is 95 wt %. At less than 10 wt %, the effect of increased cohesive force of the cured product may be reduced, while at greater than 95 wt % the adhesive force during thermo-compression bonding may be reduced. From these considerations, the minimum proportion is 30 wt % and particularly suited at 40 wt % while the maximum proportion is 88 wt % and particularly suited at 85 wt %. This proportion is based on the total weight of the ethylene-glycidyl(meth)acrylate copolymer, an optional ethylene-alkyl(meth)acrylate copolymer mentioned below, and the carboxyl group-containing rosin.

The adhesive composition may also contain an ethylene-alkyl(meth)acrylate copolymer in addition to the ethylene-glycidyl(meth)acrylate copolymer. If used, this copolymer has the function of allowing the adhesive composition precursor to melt at a relatively low temperature to facilitate melt coating, and of increasing the thermal adhesion of the adhesive composition. Also, the electron beam irradiation forms a crosslinked structure with the ethylene-glycidyl(meth)acrylate copolymer and/or the ethylene-alkyl(meth)acrylate copolymer, such that the elastic modulus is improved during thermo-compression bonding of the adhesive composition. Moreover, because the ethylene-alkyl(meth)acrylate copolymer has lower hygroscopicity than the ethylene-glycidyl(meth)acrylate, it also increases the moisture resistance of the adhesive composition or its precursor. Generally speaking, the ethylene-alkyl(meth)acrylate copolymer will have a lower softening point than the ethylene-glycidyl(meth)acrylate copolymer, and will therefore act to relieve internal stress when the cured composition is subjected to the heating cycle and thus increase adhesive performance.

The ethylene-alkyl(meth)acrylate copolymer may be obtained by polymerization of, for example, a monomer mixture containing an alkyl(meth)acrylate monomer and an ethylene monomer as the starting monomers. A third monomer such as propylene, or vinyl acetate may also be used in addition to the aforementioned monomers, so long as the effect of the invention is not hindered.

The alkyl group of the alkyl(meth)acrylate contains a minimum of 1 and a maximum of 4 carbon atoms. If more than 4 carbon atoms are in the alkyl group, it may be difficult to increase the elastic modulus of the crosslinked composition.

Useful ethylene-alkyl(meth)acrylate copolymers include a copolymer of alkyl(meth)acrylate and ethylene and a terpolymer of alkyl(meth)acrylate, vinyl acetate and ethylene. Such copolymers comprise a repeating unit polymerized from a monomer mixture of alkyl(meth)acrylate and ethylene, in a proportion of usually at least 50 wt % and particularly suited at least 75 wt % with respect to the total polymer.

The polymerization ratio the alkyl(meth)acrylate (G) and ethylene (E) in the repeating unit is in the range of preferably 60:40 to 1:99, and particularly suited at 50:50 to 5:95. If the ethylene content is too low, the improved elastic modulus by electron beam crosslinking may be reduced, whereas if the ethylene content is too high, the adhesion performance may be reduced. The ethylene-alkyl(meth)acrylate copolymer may be used as a single type or as a mixture of two or more types.

The MFR of the ethylene-alkyl(meth)acrylate copolymer as measured at 190° C. is usually at least 1 g/10 min, particularly suited at least 150 g/10 min. and most particularly suited from 200 to 1000 g/10 min, for the reasons described above. The weight-average molecular weight of the copolymer is selected so that the MFR falls within this range.

When an ethylene-alkyl(meth)acrylate copolymer is present in the adhesive composition, its proportion will usually be no greater than 80 wt %. At greater than 80 wt %, the curing properties of the composition may be reduced. The proportion of the ethylene-alkyl(meth)acrylate copolymer is in the range of usually 4-80 wt %, particularly suited at 10-60 wt % and most particularly suited at 15-50 wt %. This proportion is based on the total weight of the ethylene-glycidyl(meth)acrylate copolymer, the ethylene-alkyl(meth)acrylate copolymer and the carboxyl group-containing rosin.

The carboxyl group-containing rosin reacts with the ethylene-glycidyl(meth)acrylate copolymer during the thermosetting operation, thermally curing the adhesive composition and enhancing the adhesive performance. Useful rosins include gum rosin, wood rosin, tallow resin or chemically modified forms thereof, e.g., polymerized rosins.

The acid value of the rosin is preferably 100-300 mgKOH/g. If the acid value is too low, its has a reduced reactivity with the ethylene-glycidyl(meth)acrylate copolymer, possibly affecting the curability of the composition; whereas if it is too high, the stability during heat molding may be impaired. Here, “acid value” is the value in milligrams of the amount of potassium hydroxide required to neutralize 1 g of sample.

The softening point of the rosin is 50-200° C., and particularly suited at 70-150° C. If the softening point is too low, reaction may occur with the ethylene-glycidyl(meth)acrylate copolymer during storage resulting in lower storage stability. If the softening point is too high the reactivity is decreased, possibly resulting in reduced curability of the composition. The term “softening point” as used herein, means the value as measured according to JIS K6730.

The proportion of rosin in the adhesive composition will typically be 1-20 wt %. At less than 1 wt %, the curability and thermal adhesion of the composition may be reduced, and at higher than 20 wt %, the adhesive performance of the cured composition may be reduced. From these considerations, the range is particularly suited at 2-15 wt % and more particularly suited at 3-10 wt %. This proportion is based on the total weight of the ethylene-glycidyl(meth)acrylate copolymer, the ethylene-alkyl(meth)acrylate copolymer, when included, and the carboxyl group-containing rosin.

A single rosin may be used or a mixture of two or more. The rosin containing the carboxylic group may be used in combination with a rosin having substantially no carboxyl groups, so long as the effect of the invention is not hindered.

The adhesive composition may also contain any of various additives in addition to the aforementioned components, to the extent that the effect of the invention is not hindered. Examples of such additives include antioxidants, ultraviolet absorbers, fillers (inorganic fillers, electroconductive particles, pigments, etc.), lubricants such as waxes, rubber components, tackifiers, crosslinking agents, curing accelerators, and the like.

The curing reaction proceeds at a temperature of 150° C. or higher, with heating for a time period of from 1 minute to 24 hours, until the adhesive sheet can produce sufficient adhesive force (for example, 4-15 kg/25 mm or greater).

The adhesive sheet used for the invention may be manufactured in the following exemplary manner. First, an adhesive composition precursor is prepared comprising an ethylene-glycidyl(meth)acrylate copolymer and a rosin, and optionally an ethylene-alkyl(meth)acrylate copolymer. The precursor is then melt coated on a substrate to form a sheet of the precursor. Next, the precursor sheet is irradiated with an electron beam to form a crosslinked structure between the molecules of the polymer containing ethylene units, thereby manufacturing an adhesive sheet have the required thermoconductive properties.

The above-mentioned composition precursor is usually prepared by mixing the starting material components to substantial uniformity using a kneading or mixing apparatus. The apparatus used may be a kneader, roll mill, extruder, planetary mixer, homogenizer or the like. The mixing temperature and time are selected so as to substantially prevent reaction between the ethylene-glycidyl(meth)acrylate copolymer and rosin, which usually will be a temperature in the range of 20-120° C. and a time in the range of 1 minute to 2 hours.

The complex elastic modulus η* of the composition precursor measured under conditions of 120° C. and 6.28 rad/sec is from 500-1,000,000 poise, and particularly suited at 1200-10,000 poise. If the complex elastic modulus η* is too low it may be difficult to accomplish molding to the prescribed thickness; if it is too high, it may be difficult to accomplish continuous molding.

A liner may be used as the substrate, such as a release paper, a release film or the like. The melt coating is typically accomplished at a temperature of from 60 to 120° C. Common coating apparatus are useful for adhesive sheets of the invention, including but not limited to, a knife coater, die coater or the like. A sheet-like precursor may also be formed by extrusion without using a substrate. The electron beam irradiation is carried out, using an electron beam accelerator, to an acceleration voltage usually in the range of 150-500 keV and an absorbed dose typically in the range of from 10 to 400 kGy. Means such as punching is then used to open through-holes in a prescribed location of the adhesive sheet to form an through-opening region, or via.

The thickness of the adhesive sheet is preferably from about 0.001 mm to about 5 mm, and more preferably from 0.005 to 0.5 mm. If the sheet is too thin, handling of the adhesive sheet tends to become difficult, while if it is too thick, crosslinking becomes non-uniform in the direction of thickness, and this may reduce the reliability of the adhesive.

For the electroconductive and thermoconductive thermosetting adhesive sheet of the invention, low melting point solder is placed within the through-opening region formed in the adhesive sheet. The low melting point solder generally has a melting point of 150° C. or below, and particularly suited at a melting point of below 120° C. The solder is placed within the opening region in the adhesive sheet formed in the manner described above, and if necessary contact bonded with appropriate means such as a bonder through a release liner, to obtain a thermosetting adhesive sheet according to the invention. The contact bonding temperature is from 120 to 150° C. In this temperature range, the solder undergoes melted flow, while the thermosetting adhesive composition also melts sufficiently to allow molten adhesion between the solder and the adhesive composition, without significant curing of the adhesive composition. Furthermore, because the solder and the adhesive composition undergo molten bonding, flaking of the solder does not occur even if it is not riveted. There are no particular restrictions on the low melting point solder so long as the melting point is 150° C. or below. Useful solders include the materials mentioned in Denshi Zairyo no Handazuke Gijutsu [Electronic Material Soldering Techniques], 1st edition, 5th printing, p. 114. Suitable solders are formed from these combinations of materials: Sn/Bi, Sn/Bi/Pb, Sn/Bi/Pb/Cd, Sn/Bi/Zn, Sn/Bi/Pb/Cd/In, and the like. Also useful are Sn/In, Sn/Pb/In and the like which are commercially available from solder manufacturers and have the required low melting points of 150° C. or below. In particular, Sn/In (melting point: 117° C.) and Sn/Bi (melting point: 139° C.) are preferred as they do not contain the harmful elements lead or cadmium.

One use for the liner-attached adhesive sheet obtained in the manner described above is bonding between two adherends to form a three-layer bonded structure.

First, the liner is detached from the adhesive sheet, and the adhesive sheet is then sandwiched between a first and a second adherend, to form a laminate with the first adherend, adhesive sheet and second adherend laminated in that order. The laminate is then subjected to a thermo-compression bonding operation, at a temperature of from 120 to 300° C., and a pressure of from 0.1 kg/cm² to 100 kg/cm², to form a bonded structure with the 3 layers contact bonded together. This method allows two adherends to be bonded together with sufficient adhesive force in a time frame of only from 0.1 second to 30 seconds.

The thermosetting adhesive sheet of the invention naturally exhibits adequate adhesive force by the aforementioned thermo-compression bonding, but postcuring is done to achieve even higher adhesive forces, i.e., in the bonding method described above, the bonded structure is subjected to postcuring under conditions with a temperature of usually 120° C. or higher, and usually from 130° C. to 300° C., for a time in the range of 1 minute to 24 hours. Preferred conditions for hastening the postcuring step are 140-200° C. for 30 minutes to 1.2 hours.

The electroconductive and thermoconductive thermosetting adhesive sheet of the invention is also used, for example, as a heat radiating adhesive sheet for bonding between an electronic element such as an IC chip and heat radiating component such as a heat radiator plate for dissipation of heat generated from the element.

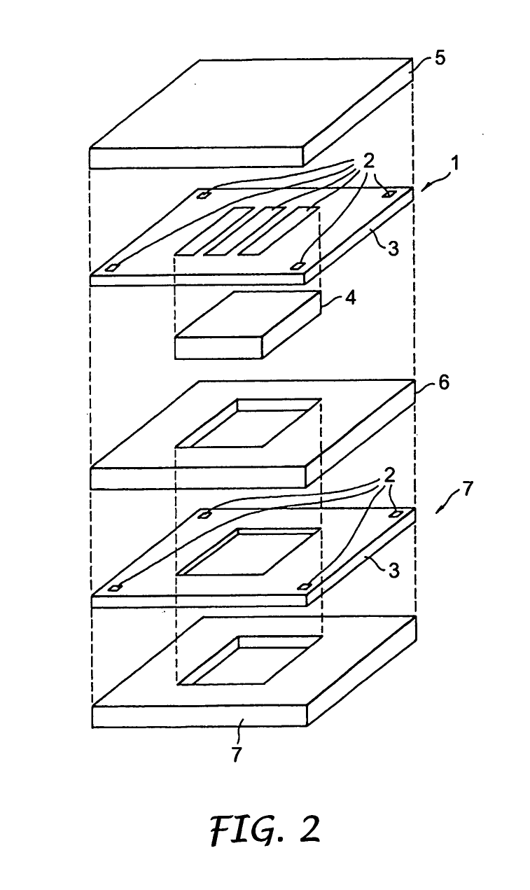

FIG. 2 shows an exploded perspective view of an embodiment of an electronic part using a thermosetting adhesive sheet according to the invention. After laminating to heat radiator plate 5, the laminated structure has thermosetting adhesive sheet 1 of the invention with region(s) having low temperature solder provided in through-holes 2, and adhesive region 3, an IC chip 4, stiffener 6 with an opening for housing IC chip 4. Adhesive sheet 1 which is a thermosetting adhesive sheet according to the invention has the same opening as stiffener 6, and TAB 7, and contact bonding is performed in the aforementioned region at a temperature of from 120 to 300° C. At least a part of solder holding region 2 of adhesive sheet 1 corresponds to the region situated on IC chip 4. This provides electric conductivity and high thermal conductivity while also allowing heat generated from the chip to be satisfactorily released. Adhesive sheet 1 also has solder placed within the region of lamination on stiffener 6. Because stiffener 6 is formed of a metal conductor such as copper, TAB 7 is in electrical continuity with the adhesive sheet 1, stiffener 6 and adhesive sheet 1, having the same opening as stiffener 6. This eliminates the need for a solder conductive path at the edge which has been necessary for conventional electronic parts. Thus, with the thermosetting adhesive sheet of the invention, the solder only needs to be placed in a retainable manner in the regions where electric conductivity and thermal conductivity are required, the amount of solder used is reduced and high thermal conductivity can be achieved. The adhesive sheet of the invention may also be used for bonding of IC chips and stiffeners with radiator plates in order to simplify electronic part manufacturing steps.

### EXAMPLES

The present invention will now be further explained by way of the following examples.

### Fabrication of Adhesive Sheet

First, 70 parts by weight of ethylene-glycidyl methacrylate copolymer CG5001 (BONDFAST,® Sumitomo Chemical Co., Ltd., MFR=350 g/10 min), 25 parts by weight of the ethylene-ethyl acrylate copolymer NUC6070 (Nihon Unica Co., Ltd., MFR=250 g/10 min) and 5 parts by weight of the carboxyl group-containing rosin KR85 (Arakawa Chemical Industries, Ltd., acid value=170 mgKOH/g) were mixed and kneaded at a temperature of 120° C. for 7 minutes. The composition was then coated onto a 100 μm release-treated polyethylene terephthalate (PET) liner using a knife coater at 150° C., to fabricate a 50 μm thermosetting adhesive sheet precursor. The composition of the precursor is shown in Table 1 below. The adhesive sheet precursor was irradiated with an electron beam at 200 kV and an absorbed dose of 150 kGy, to obtain a thermosetting adhesive sheet on a PET liner. This adhesive sheet was designated as Adhesive Sheet 1 (adhesive sheet for Comparative Example 1).

After kneading 12.5 parts by weight of CG5001 and 87.5 parts by weight of AgC2001 (silver powder by Fukuda Metal Foil & Powder Co., Ltd.), as described above, the kneaded mixture was coated onto a PET liner to obtain an adhesive sheet precursor. The composition of the precursor is shown in Table 1 below. This adhesive sheet precursor was also irradiated with an electron beam in the same manner as above to obtain a thermosetting adhesive sheet. This adhesive sheet was designated as Adhesive Sheet 2 (adhesive sheet for Comparative Example 2).

TABLE 1
Composition of adhesive sheet precursors

| | Composition (weight ratio) |
|---|---|
| Adhesive Sheet 1 and 3 precursors | CG5001/NUC6070/KR85 = 70/25/5 |
| Adhesive Sheet 2 precursor | CG5001/AgC2001 = 12.5/87.5 |

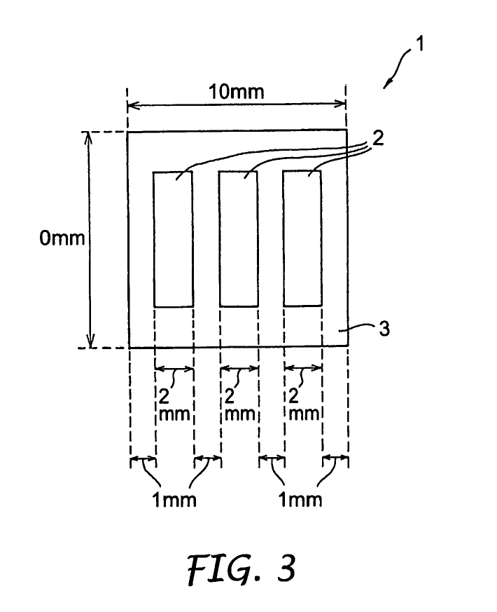

Adhesive Sheet 1 was cut to the dimensions shown in FIG. 3 to obtain a sheet with through-opening regions formed therein. A release-treated PET liner was replaced. Next, a low melting point solder ribbon with a thickness of 100 μm, a width of 1 mm and a melting point of 114° C. manufactured by Senju Metal Industry Co., Ltd. was cut to a length of 8 mm, placed in the through-opening regions of Adhesive Sheet 1, and contact bonded with a bonder to obtain thermosetting adhesive sheets according to the invention. The contact bonding pressure was 2 kg/cm², the contact bonding temperature was 127° C. and the contact bonding time was 3 seconds. Each of the adhesive sheets obtained from Adhesive Sheet 1 were designated as Adhesive Sheet 3 (adhesive sheets for Example 1).

### Fabrication of Samples for Thermal Conductivity Measurement

The PET liners were released from each of the above-mentioned adhesive sheets, and each of the adhesive sheets was used for bonding between two 500 μm thickness copper plates. For Example 1, two adhesive sheets were used for bonding, while only one sheet was used for Comparative Examples 1 and 2. The contact bonding pressure was 2 kg/cm², the contact bonding temperature was 175° C. and the contact bonding time was 10 seconds. Each of the samples was cut to a 10 mm×10 mm with a fret saw to make samples for thermal conductivity measurement. A 100 mm square, 490 μm thick stainless steel plate (SUS304 (BA)) was also used as a control sample for thermal conductivity measurement. The constructions of the measurement samples for Example 1 and Comparative Examples 1-2 and the control sample are shown in Table 2 below.

TABLE 2
Construction of measuring samples

| | Adhesive | | | Copper |
|---|---|---|---|---|
| | sheet | Thickness (μm) | Sample form | plate used |
| Example 1 | Adhesive | 100 (50 × 2) | Both sides | 500 μm |
| | Sheet 3 | | contact bonded | thickness |
| | | | with copper plates | |
| Comp. Ex. 1 | Adhesive | 50 | Both sides | 500 μm |
| | Sheet 1 | | contact bonded | thickness |
| | | | with copper plates | |
| Comp. Ex. 2 | Adhesive | 50 | Both sides | 500 μm |
| | Sheet 2 | | contact bonded | thickness |
| | | | with copper plates | |
| Control | SUS304 | 490 | Substrate alone | none |
| | (BA) | | | |

TABLE 3
Measurement results

| | Temperature | Tem- | | |
|---|---|---|---|---|
| | difference | perature | | |
| | between | difference | Thermal | Thermal |
| | upper jig | between | resistance | conductivity |
| | thermocouples | sample | of sample | of sample |
| | (° C.) | (° C.) | (° C./W) | (W/mK) |
| Example 1 | 10.8 (≈83 ± | 10.6 | ≈0.13 ± 0.02 | 7.8 ± 1 |
| | 12 W) | | | |
| Comp. Ex. 1 | 2.6 (≈20 ± | 38.2 | 1.91 ± 0.3 | 0.26 ± 0.04 |
| | 3 W) | | | |
| Comp. Ex. 2 | 3.2 (≈25 ± | 24.1 | 0.96 ± 0.15 | 5.2 ± 0.8 |
| | 4 W) | | | |
| Control | 2.8 (≈21 ± | 6.3 | 0.29 ± 0.04 | 17 ± 2 |
| | 3 W) | | | |

### Thermal Conductivity Measurement

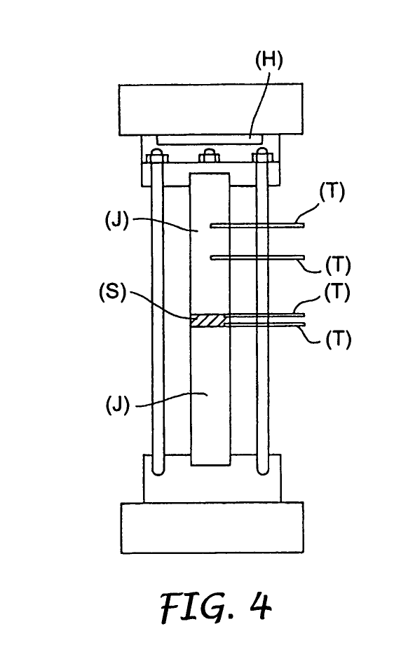

An apparatus was manufactured for measurement of thermal conductivity based on the vertical comparison method, and the thermal conductivity of each of the samples was measured. FIG. 4 is a schematic diagram of the apparatus. In the manner shown here, the sample (S) was sandwiched and anchored between two jigs. The jig (J) used was a calendering copper bar (JIS C1100, 10 mm cross-sectional diameter). The upper jig was heated by a heater (H) by WATLOW Co., and flow of heat from the heated jig through the sample to the lower jig was measured. Two K-thermocouples (T) with tip diameters of 500 μm were embedded to the center of the jig at 4 mm spacing for measurement of the heat flowing through the jig. A water cooling unit was mounted at the bottom of the opposite jig to remove heat from the sample. The amount of heat (W) flowing through the jig was measured by the temperature difference in degrees centigrade (K)) and distance between the two thermocouples and by the cross-sectional area (m²) of the calendering copper bar, using 391 W/mK as the value for the thermal conductivity of the calendering copper bar.

The sample to be measured was sandwiched between the above-mentioned jigs, anchored using silver paste, and subjected to a dead load with a weight of 3 kg. Each thermocouple (T) was mounted with a small amount of an instant bonding agent on either surface of the sample, allowing measurement of the temperature on both surfaces of the sample. Upon heating, using heater (H) on this structure, the change in temperature at each measurement point stabilized after one hour, and the temperature was measured at the two points of the upper jig and on both surfaces of the sample. A glass cover was used over the measuring sections in order to minimize the effect of the room temperature. The results of are shown in Table 3 above.

The results for the control sample shown in Table 3 indicate that the thermal conductivity of the SUS304 measured by this method was approximately 17±2 W/mK, which is close to the published value of 16.5 (W/mK (Dennetsu Kogaku Shiryo Thermoconductive Engineering Materials, Revised 4th Edition, p. 318), thus confirming the validity of this measurement. As shown in Table 3, the thermal resistance of Example 1 was lower than that of Comparative Examples 1 and 2, indicating that the thermosetting adhesive sheet of the present invention has high thermal conductivity suitable for heat radiation purposes. The amount of metal used may therefore be reduced while obtaining the same degree of heat radiation, thus providing an economical advantage.

When the thermosetting adhesive sheet of the invention is applied for the purpose of heat radiation for an electronic element in an electronic part formed by a TAB system, it is possible to bond the electronic element and a stiffener onto a radiator plate using a single adhesive sheet, thus simplifying the manufacturing steps and providing an excellent economic advantage.

1. A thermosetting adhesive sheet with electroconductive and thermoconductive properties, comprising:
a) a thermosetting adhesive sheet having two major surfaces, composed of a thermosetting adhesive composition comprising an ethylene-glycidyl(meth)acrylate copolymer and a rosin, said rosin containing a carboxyl group, where crosslinking is formed between the ethylene of said copolymer by electron beam radiation, and having at least one through-opening region formed at a prescribed location,
b) low melting point solder placed within at least one through-opening region formed at the prescribed location, and
c) molten bonding between the solder and the adhesive composition.

2-5. (canceled)

6. A thermosetting adhesive sheet according to claim 1 wherein the melting point of the solder is below about 120° C.

7. A thermosetting adhesive sheet with electroconductive and thermoconductive properties, comprising:
(a) a thermosetting adhesive sheet that is a solid at room temperature but can be thermo-compression bonded at temperatures of about 100 to about 200° C., and having a through-opening region formed at a prescribed location,
(b) low melting point solder placed within at least one-through-opening region formed at the prescribed location, and
(c) molten bonding between the solder and the adhesive composition.

8. A thermosetting adhesive sheet according to claim 7 wherein the melting point of the solder is below about 120° C.

9. A method for using the thermosetting adhesive sheet according to claim 1 comprising:
Forming a laminate structure having a first adherend and a second adherend and an adhesive layer between the two adherend layers, and
Subjecting the laminate to a thermocompression bonding operation at a temperature of about 120 to about 300° C. and a pressure of about 0.1 to about 100 kg/cm2.

10. A method for using the thermosetting adhesive sheet according to claim 7 comprising:
Forming a laminate structure having a first adherend and a second adherend and an adhesive layer between the two adherend layers, and
Subjecting the laminate to a thermocompression bonding operation at a temperature of about 120 to about 300° C. and a pressure of about 0.1 to about 100 kg/cm2.
